(19) United States
(12) Patent Application Publication
(10) Pub. No.: US 2010/0152012 A1
(43) Pub. Date: Jun. 17, 2010

(54) Finger Manipulated Game With Replaceable Indicia

(76) Inventor: Jeffrey Jurgensen, Chicago, IL (US)

Correspondence Address: JONES DAY, 222 EAST 41ST ST, NEW YORK, NY, 10017, US

(21) Appl. No.: 12/528,590

(22) PCT Filed: Sep. 24, 2008
(86) PCT No.: PCT/US08/77501

§ 371 Date: Aug. 25, 2009

Related U.S. Application Data
(60) Provisional application No. 60/975,849, filed on Sep. 28, 2007.

(51) Int. Cl. B31F 7/00

(52) U.S. Cl. 493/409; 493/405

(57) ABSTRACT

A method of forming a cootie catcher by removing material from a generally square piece of material, wherein removed pieces enable the piece of materia! to be folded and for easier manipulation of the cootie catcher. A method of forming a cootie catcher by forming a sheet of material having fold lines as shown in FIG. 2, removing material along the fold lines to assist in folding the cootie catcher, and folding along the fold lines to create the cootie catcher.

### BACKGROUND OF THE INVENTION

Generally, the present invention relates to a finger manipulated game and method of making same.

Some children are attracted to games or toys that convey secret messages. Toys that “tell fortunes” or purport to predict some future event also have great attraction to children. A common school toy for elementary school children is a piece of plain square paper that is folded in such a way that it may be manipulated on the fingers to multiple distinct open positions. When in these open positions, the toy has flaps that typically have visible numbers. A player then chooses one of these numbers. If playing in the classic way, the flap with this number is opened to reveal a secret message or fortune.

This toy is often known among children as a “fortune teller,” a “cootie catcher,” “finger snapper,” or some other name. The toy is a folded piece of paper that may include writings or other demarcations on the inner and outer surfaces. Additionally, the folded pieces are formed such that there are flaps that are lifted to reveal an underlying message, fortune, trivia, etc. There are articles and information on the Internet that provide instructions on instructs how to make a folded fortune-telling toy. In addition, The Cootie Catcher Book by the Editors of Klutz (1997 Klutz Publishing) discusses how to make such a toy and has several tear-out pages pre-printed with artistic designs and pre-printed messages.

One popular way to use the toy is now described. One player, often referred to as a fortune teller, holds the toy and another player either answers a question or otherwise selects a flap. For example, a player may be asked to choose a color. The fortune teller spells the name of the color name out while opening and closing the fortune teller one time for every letter of the color. This may be repeated any number of times using whatever criteria the players desire. Once the position of the toy is selected, the player selects one of the visible flaps, either by answering a question or directly selecting a flap. The chosen. Then the player is told to again choose a number from 1 to 10 and the cootie catches is opened and closed that number of times. Open and close the fortune teller that number of times. The player then selects 1 of the 4 visible flaps revealed. When the flap is opened and the players fortune is revealed.

Despite the popularity of these child-made toys, they suffer several disadvantages by nature of being constructed from plain paper:
(a) The lifetime of the toy is limited because paper can be easily worn or ripped during use; and
(b) The visual appeal of plain paper is limited.

Several attempts have been made to overcome some of these disadvantages. For example, one development involved the use of a folded fortune pouch game that is made of material that is more durable to extend its useful life. While successful in this way, this toy still suffers from several disadvantages. The use of slits to hold the message cards relies on the stiffness of the card to stay in. The toy also relies on the card and the slits to be in good condition and properly sized in order to function most effectively. If either the card or slit is not in good condition or is improperly sized, the message cards will fall out. Additionally, since plain paper is used for the toy, it is not likely that the paper will be able to support slits and message cards for an extended period. This results in degradation of the toy. Further, the message cards must be of a certain stiffness and shape. Soft or bendable material or unique shapes cannot be used. The message cards must be formed of material that is of a thickness that fits easily within the slits.

### SUMMARY OF THE INVENTION

Generally, the present invention provides a method of forming a cootie catcher by removing material from a generally square piece of material, wherein removed pieces enable the piece of material to be folded and more easily manipulated. The material is removed in an oblong or elongated configuration along the fold lines at pre-determined locations to aid in the folding of the cootie catcher.

A method of forming a cootie catcher by forming a sheet of material having fold lines as shown in FIG. 2, removing material along the fold lines to assist in folding the cootie catcher, and folding along the fold lines to create the cootie catcher. The material is removed in an oblong or elongated configuration along the fold lines at pre-determined locations to aid in the folding and manipulation of the cootie catcher.

These and other objects, advantages and features of the invention will be more fully understood and appreciated by reference to the description of the current embodiment and the drawings.

### BRIEF DESCRIPTION OF THE DRAWINGS

FIG. 1 shows the toy of the present invention, in a folded configuration.

FIG. 2 shows the toy in a flat or unfolded configuration.

FIG. 3 shows the suggested folding pattern.

### DETAILED DESCRIPTION OF THE INVENTION

The game is formed as a resilient sheet of material 10. Any material can be used such as card stock or the like. The material that allows the game to be foldable without hindering the sheets ability to maintain form may be used. Examples of such materials include, but are not limited to, laminated paper, card stock, paper having a protective coating thereon and/or therein, a synthetic material that is able to be perforated and folded.

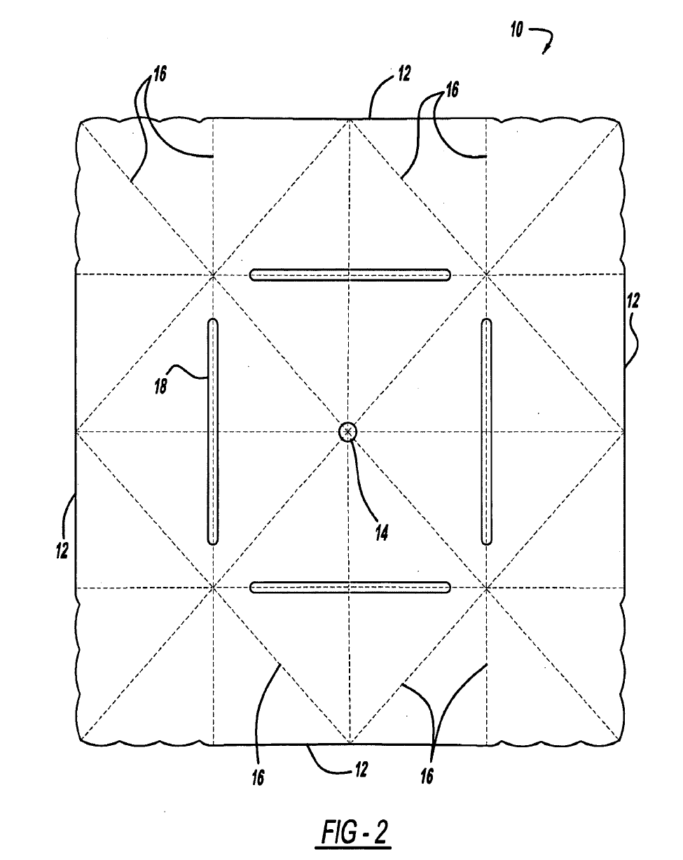

The sheet 10 is a single piece of material that is die-cut, or otherwise cut using techniques known to those of skill in the art, for forming a sheet 10 as shown in FIG. 2. In the current embodiment, the sheet 10 is generally square-shaped and has four exterior sides 12 in the unfolded configuration. The sides can be straight as shown in FIG. 2, or can include indentations, notches, cutouts, or other shapes that minimize the amount of material present on the sides 12 of the sheet 10. Minimizing the amount of material present on the sides 12 of the sheet 10 enables the user to both more easily fold the sheet 10 and keep the sheet 10 in the folded configuration. The sheet 10 can also includes cuts (not shown) that enable to the flaps, when folded, to show each of the messages individually. FIG. 2 shows a central bore, opening or hole 14 that can be removed either during formation of the sheet 10 or while the sheet is formed into the folded configuration. The sheet 10 also includes numerous fold lines 16, depicted in FIG. 2 as dashed or dotted lines. These are lines 16 that can be printed, but are not necessarily printed, on the sheet 10 to provide the user with indications of where folds should occur. Additionally, the lines 16 can include reinforcing material that help limit or prevent tears along the fold lines 16. The reinforcing material can be an additional amount of the sheet material or it can be formed of another material that is compatible with the sheet and can thus be affixed to the sheet at the fold line 16. While FIG. 2 depicts scalloped edges, straight edges, or other shapes, can also be formed without departing from the spirit of the present invention.

Additionally, the long, oblong markings/cutouts 18 depict additional cut out formations that are formed to permit easier folding of the game. The term “oblong” as used herein is intended to include elongated squares or circles. The cutouts 18 are used to enhance the ease with which the game functions.

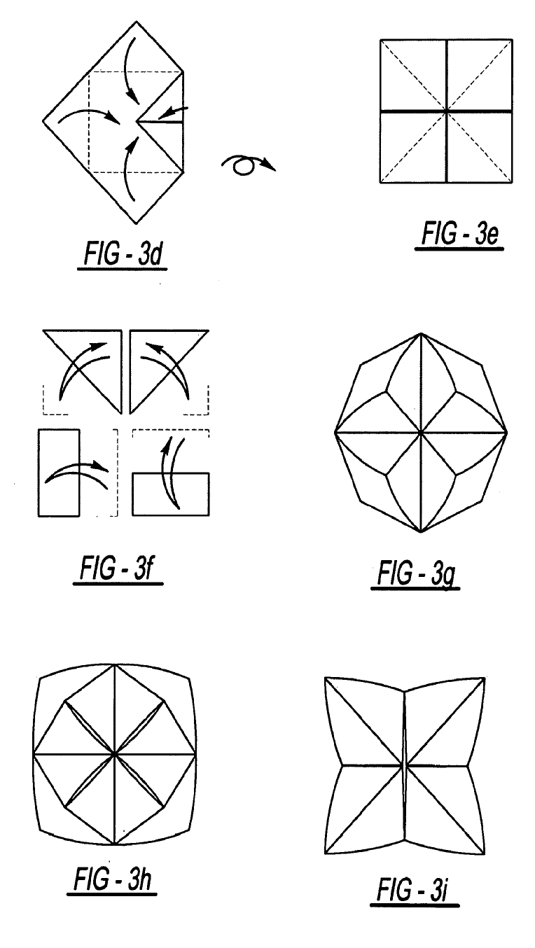

The game is formed of a foldable sheet including a rectangular/square sheet of material, which may be fabricated from plastic, thick paper or synthetic material or the like, having the four corners of the sheet being first folded backwardly, as indicated by arrow in FIG. 3, to the center forming a second rectangle/square of smaller dimensions. The second rectangle/square is illustrated in the figures. Then folding of the four corners of the second rectangle/square sheet inwardly to the center, as illustrated in the figures, in the direction of arrow forms a third rectangle/square of still smaller dimensions. Accordingly, the game may vary in size for both children, adults, a miniature size, travel size and other sizes.

The current embodiment of the game is formed in the manner set forth in the figures. The inner end of the outer flaps extend in vertically spaced relationship to each other. In a similar manner the bottom end of each flap, also extends in substantially parallel spaced relationship to each other in the flat position of the game.

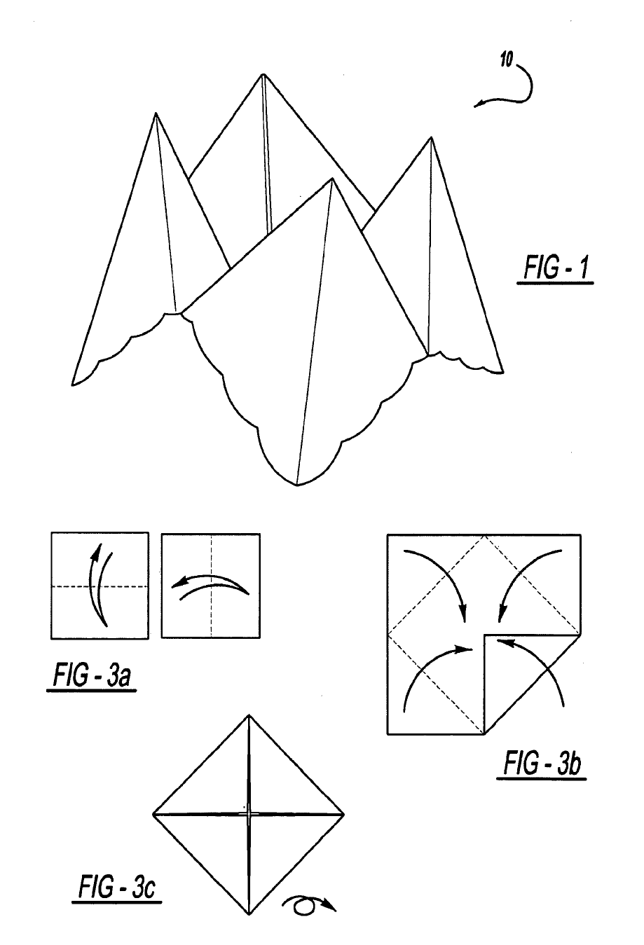

The folding of the sheet also produces a plurality of flexible inner flaps that are integrally formed with the body portion and hingeably secured thereto. The flaps are maintained in a closed position such that the flaps overlap the body portion to conceal a message. As shown in FIG. 1 the flaps extend upwardly from the body portion, with each inner flap having a viewable outer surface and an inner surface, and the message or fortune being removably connected to each of the flexible inner flaps on each inner surface.

The messages or fortunes can be, but are not limited to, removable stickers, magnets, a reusable and repositional cling/adhesive material that clings to the inner surface but can be easily removed, examples of which are well known to those of skill in the art, or other elements that can be removably or reusably affixed to the surface. The messages or fortunes can be written messages, symbols, or blank forms that can be filled out by the players of the toy. The messages may be removed when the toy is in the position.

In the current embodiment, each one of the inner flaps, four being illustrated, is in the form of a triangle of generally equal size. One corner of each triangle is folded over the body portion, as shown in FIG. 3, thus creating flaps. As disclosed above, the flaps are movable between and open and closed position and when the game is lying flat the flaps are maintained in a closed position. Accordingly, the last folded corners form the flexible inner flaps such that the corners coincide with the inner pointed end of each flap. The panels extend between the inner flaps and outer flaps.

Each of the flaps includes at least a first indicia and a second indicia. The indicia are provided on the viewable outer surface. The first indicia and second indicia are not viewable at the same time, therefore when the panels in a first positioned the first indicia are viewable and the second indicia are viewable when the panels are positioned in another position, which occurs when the device is manipulated by the fingers and thumbs of the player.

The first indicia is contained on oppositely disposed inner flaps and include the indicia information, for example, ONE, TWO, on one flap and FIVE, SIX, on another flap. The second indicia includes the different information, for example, THREE, FOUR, on one flap and SEVEN, EIGHT on another flap.

Obviously, the information set forth on the inner flaps may vary and is not limited to any numbering sequence. In addition, third indicia is provided on each of the outer flaps. For example, the third indicia can include reference to the colors RED, BLUE, GREEN, and ORANGE.

The game can be played in various ways, but particularly the position can vary such that either the first indicia is viewable in the position or the second indicia is viewable when the game is held in the position. The fingers of each hand are initially interposed between the outer flaps and respective panels. The thumb is placed between the other set of flaps and the other panel. In this position with the fingers and thumbs compressing slightly adjacent the ends, the second indicia will be viewable.

The transition step is accomplished by initially moving the respective thumb and fingers towards each other in the direction of arrows, such that the position is reached and the first indicia is viewable. The hands of the player are in a prayer position to obtain this arrangement. Movement is readily obtained by a user of the game. In addition, movement is also easily obtained.

The rules of the game permit the player to maneuver the game such that looking down from the top you would see the written numbers of the first and second indicia.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1-7. (canceled)

8. A method of forming a toy by:
forming a sheet of material having fold lines;
removing material along the fold lines to assist in folding the toy; and
folding along the fold lines to create the toy.

9. The method of claim 8, wherein said removing step includes removing the material using die cutting tools.

10. The method of claim 9, wherein said removing step includes die cutting an oblong shape of material along the fold lines to remove the material.

11. The method of claim 8, wherein said forming step includes forming the sheet from a material selected from the group consisting of laminated paper, synthetic material, and plastic.

12. A toy having multiple openings formed therein, wherein said openings are formed along fold lines used to fold and maintain the toy into proper configuration.

13. The toy of claim 12, wherein said openings include a central opening.

14. The toy of claim 12, further including removable messages removably attached to flaps formed after the toy is folded.

15. The toy of claim 14, wherein said removable message is attached using means selected from the group consisting of magnets, static cling material, and removable stickers.

16. A method of forming a toy by:
providing a generally square sheet of material;
determining first, second, and third vertical fold lines spaced equidistant apart between side lateral edges of the material;
determining first, second, and third horizontal fold lines spaced equidistant apart between the top and bottom edges of the material;
removing an elongated section of material along the first and third vertical fold lines between the first and third horizontal fold lines; and
removing an elongated section of material along the first and third horizontal fold lines between the first and third vertical fold lines;
thereby enabling the material to be folded to form the toy.

17. The method of claim 16, further including removing a piece of material from the center of the generally square sheet.

18. The method of claim 16, further including removing material from the edges of the generally square sheet or the toy.

19. The method of claim 16, further including folding the sheet to form the toy.

20. The method of claim 19, wherein said folding step includes folding the sheet along the fold lines.

21. The method of claim 16, wherein said removing steps include removing the material using die cutting tools.

22. The method of claim 16, wherein said sheet is selected from the group consisting of laminated paper, card stock, paper having a protective coating thereon, paper having a protective coating therein, synthetic material, and plastic.
